(19) United States
(12) Patent Application Publication
(10) Pub. No.: US 2025/0079444 A1
(43) Pub. Date: Mar. 6, 2025

(54) HIGH-VOLTAGE TERNARY POSITIVE ELECTRODE MATERIAL AND PREPARATION METHOD THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(72) Inventors: Aixia LI, Foshan, Guangdong (CN); Haijun YU, Foshan, Guangdong (CN); Changdong LI, Foshan, Guangdong (CN); Yinghao XIE, Foshan, Guangdong (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(21) Appl. No.: 18/288,685

(22) PCT Filed: Sep. 22, 2022
(86) PCT No.: PCT/CN2022/120633

§ 371 Date: Oct. 27, 2023

(30) Foreign Application Priority Data
Jul. 27, 2022 (CN) 202210892129.2

(51) Int. Cl. H01M 4/36; H01M 4/525; H01M 4/62; H01M 10/42

(52) U.S. Cl. CPC H01M 4/366; H01M 4/525; H01M 4/62; H01M 10/4235

(57) ABSTRACT

A high-voltage ternary positive electrode material includes ternary positive electrode active material particles and a flexible coating body, the flexible coating body being coated on surfaces of the ternary positive electrode active material particles; wherein, the flexible coating body includes a mixture of polyaniline and a polyurethane elastomer.

### TECHNICAL FIELD

The present invention relates to the technical field of lithium ion battery positive electrode materials, and more particularly, to a high-voltage ternary positive electrode material and a preparation method thereof.

### BACKGROUND

Performances of lithium-ion batteries are closely related to performances of selected electrode materials of the lithium-ion batteries. Traditional positive electrode material lithium cobaltate has a wide discharging window and good cycle character, but the high cobalt content in the cathode material lithium cobaltate will pollute the environment, and it is difficult for the positive electrode material lithium cobaltate to meet the requirements of high capacity, high energy density and safety performance. In recent years, ternary positive electrode materials have integrated the comprehensive characteristics of lithium cobalt oxide, lithium nickel oxide and lithium manganese oxide battery positive electrode materials, reduced the problem of environmental pollution caused by high cobalt content, and realized the complementarity of the structures and properties of the three materials, and have become one of the most potential positive electrode materials with the characteristics of high capacity greater than 150 mAh/g, good cycle performance, simple synthesis process and environmental friendliness.

However, when the ternary positive electrode material is charged and discharged at high voltage and high temperature, the ternary positive electrode material particles are easily broken due to the large amount of lithium ions intercalated and intercalated, intense reaction and strong anisotropic stress, so as to lead to more side reactions, and finally affect the cycle performance and safety performance of the battery.

### SUMMARY

The object of the present invention is to overcome the shortcomings of the existing technology, and provide a high-voltage ternary positive electrode material and a preparation method thereof with good cycle performance and high safety performance.

The object of the present application is achieved by the following technical solutions.

A high-voltage ternary positive electrode material comprises ternary positive electrode active material particles and a flexible coating body, and the flexible coating body is coated on surfaces of the ternary positive electrode active material particles;
the flexible coating body comprises a mixture of polyaniline and a polyurethane elastomer.

In one embodiment, the ternary positive electrode active material is Li₁₊ₓNiₐCo_{b}Mn_{c}O₂, 1/3≤a≤0.8, 0.1≤b≤1/3, 0.1≤c≤1/3, 0≤x<0.2, and a+b+c=1.

In one embodiment, the ternary positive electrode active material is LiNi_{1/3}Co_{1/3}Mn_{1/3}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂ or LiNi_{0.8}Co_{0.1}Mn_{0.1}O₂.

In one embodiment, the polyaniline is modified polyaniline doped with phosphotungstic acid.

A preparation method of a high-voltage ternary positive electrode material used for preparing the high-voltage ternary positive electrode material according to any one of the embodiments above, wherein the preparation method of the high-voltage ternary positive electrode material comprises the following steps of:
acquiring a flexible coating;
dispersing the flexible coating; and
adding the ternary positive electrode active material into the dispersed flexible coating for coating operation, so that surfaces of ternary positive electrode active material particles are coated with a flexible coating body to obtain the high-voltage ternary positive electrode material.

In one embodiment, the acquiring the flexible coating specifically comprises the following steps of:
acquiring aniline;
adding polyurethane elastomer into the aniline for dispersion and adhering operations, so that the aniline is adhered to the polyurethane elastomer to obtain a coating liquid; and
carrying out in-situ oxidation polymerization operation on the coating liquid to obtain the flexible coating.

In one embodiment, a mass ratio of the aniline to the polyurethane elastomer is (0.5 to 1.25): 1.

In one embodiment, before the step of adding the polyurethane elastomer into the aniline for dispersion and adhering operations, the acquiring the flexible coating specifically further comprises the following step of:
dispersing and mixing the aniline and a phosphotungstic acid.

In one embodiment, a mass ratio of the aniline to the phosphotungstic acid is 1:(5 to 10).

In one embodiment, H₂O₂ is used to carry out the in-situ oxidation polymerization operation on the coating liquid.

Compared with the existing technology, the present application at least has the following advantages:

According to the high-voltage ternary positive electrode material of the present invention, the flexible coating body is the mixture of the polyaniline and the polyurethane elastomer and coated on the outer surfaces of the ternary positive electrode active material particles, so that the high-voltage ternary positive electrode material becomes a plurality of ternary positive electrode active material particles the surfaces of which are coated with the mixed polyaniline and polyurethane elastomer. Because the flexible coating body containing the mixture of the polyaniline and the polyurethane elastomer has both flexibility and conductivity, the flexible coating body can adapt to interface changes of the ternary positive electrode active material particles, so as to maintain interface stability and dynamic integrity of the ternary positive electrode active material particles during the charging and discharging process of the battery containing the high-voltage ternary positive electrode material (i.e., during a lithium deintercalation process). Meanwhile, the flexible coating body can provide a uniform lithium ion transmission interface for lithium ion deintercalation, thereby reducing side reactions caused by easy breakage of the ternary positive electrode active material particles and addressing the problem of finally affecting the cycle performance and safety performance of the battery, and thereby improving the cycle performance and safety performance of the battery.

### BRIEF DESCRIPTION OF THE DRAWINGS

In order to more clearly illustrate the technical solutions of the embodiments of the present invention, the drawings that are required to describe the embodiments will be briefly introduced below. It should be understood that the drawings below only illustrate some embodiments of the present invention, and should not be regarded as limiting the scope. Those having ordinary skills in the art can obtain other related drawings according to these drawings without paying creative work.

FIG. 1 is a flow chart of a preparation method of a high-voltage ternary positive electrode material according to one embodiment of the present invention;

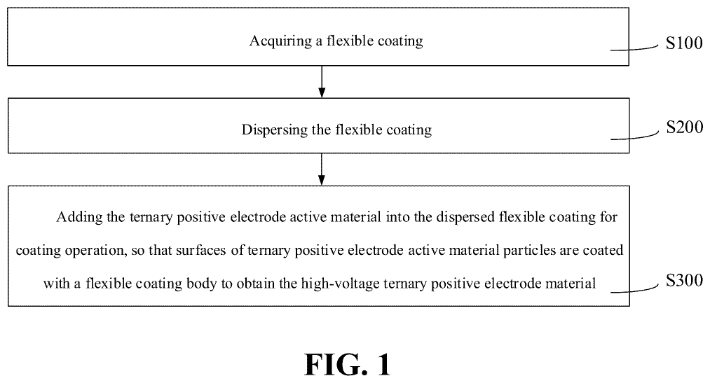

FIG. 2 is an SEM graph of a high-voltage ternary positive electrode material in Embodiment 3 of the present invention; and

FIG. 3 is another SEM graph of the high-voltage ternary positive electrode material in Embodiment 3 of the present invention.

### DETAILED DESCRIPTION

In order to facilitate the understanding of the present invention, the present invention will be more fully described below with reference to the relevant drawings. The preferred embodiments of the present invention are shown in the drawings. However, the present invention may be implemented in many different forms and is not limited to the embodiments described herein. On the contrary, these embodiments are provided for a more thorough and comprehensive understanding of the contents disclosed by the present invention.

It should be noted that when an element is called to be “fixed” to another element, it may be directly arranged on another element or there may be an intermediate element. When an element is considered to be “connected” to another element, it may be directly connected to another element or there may be an intermediate element at the same time. Terms such as “vertical”, “horizontal”, “left”, “right”, and similar expressions used herein are only for the purpose of illustration and do not mean that they are the only implementation ways.

Unless otherwise defined, all the technical and scientific terms used herein have the same meanings as those commonly understood by those skilled in the art of the present invention. Terms used herein in the specification of the present invention are for the purpose of describing specific embodiments only and are not intended to limit the present invention. The term “and/or” as used herein includes any and all combinations of one or more of the associated items listed.

The present application provides a high-voltage ternary positive electrode material. The high-voltage ternary positive electrode material above comprises ternary positive electrode active material particles and a flexible coating body, and the flexible coating body is coated on surfaces of the ternary positive electrode active material particles. The flexible coating body comprises a mixture of polyaniline and a polyurethane elastomer.

According to the high-voltage ternary positive electrode material, the flexible coating body is the mixture of the polyaniline and the polyurethane elastomer and coated on the outer surfaces of the ternary positive electrode active material particles, so that the high-voltage ternary positive electrode material becomes a plurality of ternary positive electrode active material particles the surfaces of which are coated with the mixture of the polyaniline and the polyurethane elastomer. Because the flexible coating body containing the mixture of the polyaniline and the polyurethane elastomer has both flexibility and conductivity, the flexible coating body can adapt to interface changes of the ternary positive electrode active material particles, so as to maintain interface stability and dynamic integrity of the ternary positive electrode active material particles during the charging and discharging process of the battery containing the high-voltage ternary positive electrode material (i.e., during a lithium deintercalation process). Meanwhile, the flexible coating body can provide a uniform lithium ion transmission interface for lithium ion deintercalation, thereby reducing side reactions caused by easy breakage of the ternary positive electrode active material particles and addressing the problem of finally affecting the cycle performance and safety performance of the battery, and thereby improving the cycle performance and safety performance of the battery.

In one embodiment, a mass ratio of the flexible coating body to the ternary positive electrode active material particles is (2 to 8): 100, which thereby ensures the sufficient coating of the ternary positive electrode active material particles and further realizes the improvement of the cycle performance and the safety performance.

In one embodiment, the flexible coating body comprises a plurality of flexible coating monomers, each flexible coating monomer comprises polyurethane elastomer particles and polyaniline film, the polyaniline film is coated on surfaces of the polyurethane elastomer particles, and the polyurethane elastomer particles of the plurality of flexible coating monomers are uniformly stacked and coated on the surfaces of the ternary positive electrode active material particles, thus ensuring the flexibility and conductivity of the flexible coating body, and further improving the cycle performance and the safety performance of the battery.

In one embodiment, the flexible coating body comprises a plurality of flexible coating monomers, each flexible coating monomer comprises polyurethane elastomer particles and modified polyaniline film doped with phosphotungstic acid, the modified polyaniline film doped with phosphotungstic acid is coated on surfaces of the polyurethane elastomer particles, and the polyurethane elastomer particles of the plurality of flexible coating monomers are uniformly stacked and coated on the surfaces of the ternary positive electrode active material particles.

In one embodiment, the polyaniline is modified polyaniline doped with phosphotungstic acid. It may be understood that the phosphotungstic acid is a polynuclear complex, which not only has the characteristics of complex and metal oxide, but also has unique redox and strong acidity, can provide proton and polyaniline to form doped polymer, that is, the modified polyaniline doped with phosphotungstic acid, and the phosphotungstic acid embedded in a polyaniline matrix still maintains the structural characteristics thereof. Polyaniline can be polymerized on the surface of the polyurethane elastomer by in-situ oxidation polymerization. In this process, the doping of the polyaniline by the phosphotungstic acid is realized, which not only keeps the structure of the polyaniline, but also keeps the structure of the phosphotungstic acid, and the conductivity of the polyaniline doped with the phosphotungstic acid is obviously improved. At the same time, acidity and alkalinity of the phosphotungstic acid are effectively adjusted due to protonation, which reduces acid-base catalytic activity of the phosphotungstic acid and reduces influences of the phosphotungstic acid on mechanical properties of the high-voltage ternary positive electrode material.

The present application further provides a preparation method of a high-voltage ternary positive electrode material. In order to better understand the preparation method of the high-voltage ternary positive electrode material of the present application, the preparation method of the high-voltage ternary positive electrode material of the present application will be further described in detail below.

An embodiment of the preparation method of the high-voltage ternary positive electrode material comprises some or all of the following steps.

At S100, a flexible coating is acquired. It may be understood that the flexible coating has good flexibility and conductivity, and acquiring the flexible coating to coat the ternary positive electrode active material enables the flexible coating to adapt to interface changes of the ternary positive electrode active material particles, so as to maintain interface stability and dynamic integrity of the ternary positive electrode active material particles during a lithium deintercalation process of a battery containing the high-voltage ternary positive electrode material. Meanwhile, the flexible coating body can provide a uniform lithium ion transmission interface for lithium ion deintercalation, thereby reducing side reactions caused by easy breakage of the ternary positive electrode active material particles and addressing the problem of finally affecting the cycle performance and safety performance of the battery, and thereby improving the cycle performance and safety performance of the battery.

At S200, the flexible coating is dispersed. It may be understood that after dispersing the flexible coating first is beneficial for the ternary positive electrode active material to be evenly mixed in the flexible coating body, thus ensuring a further coating effect of the ternary positive electrode active material.

At S300, the ternary positive electrode active material is added into the dispersed flexible coating for coating operation, so that surfaces of ternary positive electrode active material particles are coated with a flexible coating body to obtain the high-voltage ternary positive electrode material. It may be understood that coating the flexible coating on the surface of the ternary positive electrode active material is to form the flexible coating body on the surface of the ternary positive electrode active material. After the flexible coating is dispersed, the ternary positive electrode active material is added for coating, which thereby improves mixing uniformity of the ternary positive electrode active material and the flexible coating, and further improves a coating effect of the ternary positive electrode active material, i.e., thereby improves a coating rate of the ternary positive electrode active material and improves particle size uniformity of the high-voltage ternary positive electrode material.

According to the preparation method of the high-voltage ternary positive electrode material, the flexible coating body is acquired, and the ternary positive electrode active material is further added for coating after the flexible coating, so that the flexible coating body is formed on the surface of the ternary positive electrode active material, which thereby improves the mixing uniformity of the ternary positive electrode active material and the flexible coating, so as to thereby improve the coating rate of the ternary positive electrode active material and improve the particle size uniformity of the high-voltage ternary positive electrode material. Moreover, because the flexible coating body has better flexibility and conductivity, the flexible coating body can adapt to interface changes of the ternary positive electrode active material particles, so as to maintain interface stability and dynamic integrity of the ternary positive electrode active material particles during the lithium deintercalation process of the battery containing the high-voltage ternary positive electrode material. Meanwhile, the flexible coating body can provide a uniform lithium ion transmission interface for lithium ion deintercalation, thus reducing side reactions caused by easy breakage of the ternary positive electrode active material particles and addressing the problem of finally affecting the cycle performance and safety performance of the battery, and thereby improving the cycle performance and safety performance of the battery.

In one embodiment, the ternary positive electrode active material is Li₁₊ₓNiₐCo_{b}Mn_{c}O₂, 1/3<a≤0.8, 0.1≤b≤1/3, 0.1≤c≤1/3, 0≤x<0.2, and a+b+c=1, which is well adapted to the flexible coating, thus being beneficial to improve a specific capacity, the cycle performance and the safety performance of the high-voltage ternary positive electrode material.

In one embodiment, the ternary positive electrode active material is LiNi_{1/3}Co_{1/3}Mn_{1/3}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂ or LiNi_{0.4}Co_{0.2}Mn_{0.4}O₂, which is well adapted to the flexible coating, thus being beneficial to improve a specific capacity, the cycle performance and the safety performance of the high-voltage ternary positive electrode material.

In one embodiment, the acquiring the flexible coating specifically comprises the following steps of:
acquiring aniline;
adding polyurethane elastomer into the aniline for dispersion and adhering operations, so that the aniline is adhered to the polyurethane elastomer to obtain a coating liquid; and
carrying out in-situ oxidation polymerization operation on the coating liquid to obtain the flexible coating.

It may be understood that because the polyaniline is difficult to melt, mechanical blending, such as mixing and melting the polyaniline and the polyurethane elastomer, needs to increase an amount of the polyaniline used, and even so, it is difficult to fully and uniformly mix the polyaniline and the polyurethane elastomer, which affects performances of the coating layer of the ternary positive electrode active material. Therefore, in one embodiment, the aniline is acquired and first adhered to the polyurethane elastomer, and then the in-situ oxidation polymerization operation is carried out, so that the aniline undergoes oxidative polymerization to form a polyaniline film on the polyurethane elastomer, which thereby ensures the mixing uniformity of the polyurethane elastomer and the polyaniline, and thereby ensures that the flexible coating has better flexibility and conductivity, thereby improving the cycle performance and the safety performance of the battery.

In one embodiment, a mass ratio of the aniline to the polyurethane elastomer is (0.5 to 1.25): 1, which better ensures the sufficient coating of the polyurethane elastomer, effectively improves the conductivity of the polyurethane elastomer under the condition of ensuring the flexibility of the polyurethane elastomer, and further ensures the flexibility and conductivity of the flexible coating.

In one embodiment, before the step of adding the polyurethane elastomer into the aniline for dispersion and adhering operation, and after the step of acquiring the aniline, the acquiring the flexible coating specifically further comprises the following step of: dispersing and mixing the aniline and a phosphotungstic acid, which ensures that the aniline can effectively combine with protons and undergo in-situ oxidation polymerization operation to form the polyaniline film on the surface of the polyurethane elastomer when carrying out the in-situ oxidation polymerization operation on the coating liquid, and meanwhile, better ensures the effective doping and embedding of the phosphotungstic acid into the polyaniline film, and effectively ensures the structural characteristics of the phosphotungstic acid at the same time, thereby ensuring the flexibility and conductivity of the flexible coating obtained through the in-situ oxidation polymerization operation.

In one embodiment, a mass ratio of the aniline to the phosphotungstic acid is 1:(5 to 10), which better ensures the effective performing of the in-situ oxidation polymerization, i.e., better ensures the modified polyurethane doped with the phosphotungstic acid, and better improves the conductivity of the polyurethane elastomer.

In one embodiment, H₂O₂ is used to carry out the in-situ oxidation polymerization operation on the coating liquid, which preferably realizes polymerization and oxidation of the aniline.

In one embodiment, the step of using H₂O₂ to carry out the in-situ oxidation polymerization operation on the coating liquid specifically comprises the step of dropwise adding H₂O₂ into the coating liquid and reacting at room temperature for 20 hours to 25 hours.

In one embodiment, a dispersant is used to perform particle dispersing treatment on the coating liquid.

In one embodiment, the step of performing particle dispersing treatment on the coating liquid comprises: under a rotating speed of 100 RPM, adding the dispersant into the coating liquid and stirring for 30-50 minutes, which preferably realizes the sufficient and uniform dispersion of the coating liquid.

In one embodiment, the dispersing agent is a dodecylbenzenesulphonic acid, which has a better dispersing effect on the coating liquid, so that the dispersion uniformity of the coating liquid is better realized.

In one embodiment, before acquiring the flexible coating and after the step of carrying out the in-situ oxidation polymerization operation on the coating liquid, the preparation method of the high-voltage ternary positive electrode material further comprises the following step of: drying the coating liquid after the in-situ oxidation polymerization operation to reduce residual water or solvent of the high-voltage ternary positive electrode material, so as to preferably ensure electrochemical performances of the high-voltage ternary positive electrode material.

In one embodiment, the step of drying the coating liquid specifically comprises: drying the coating liquid after the in-situ oxidation polymerization operation at 55° C. to 60° C. for 20 hours to 25 hours, which better reduces the residual water or solvent of the high-voltage ternary positive electrode material, so as to preferably ensure electrochemical performances of the high-voltage ternary positive electrode material.

Compared with the existing technology, the present application at least has the following advantages:

According to the high-voltage ternary positive electrode material of the present invention, the flexible coating body is the mixture of the polyaniline and the polyurethane elastomer and coated on the outer surfaces of the ternary positive electrode active material particles, so that the high-voltage ternary positive electrode material becomes a plurality of ternary positive electrode active material particles the surfaces of which are coated with the mixture of the polyaniline and the polyurethane elastomer. Because the flexible coating body containing the mixture of the polyaniline and the polyurethane elastomer has both flexibility and conductivity, the flexible coating body can adapt to interface changes of the ternary positive electrode active material particles, so as to maintain interface stability and dynamic integrity of the ternary positive electrode active material particles during the charging and discharging process of the battery containing the high-voltage ternary positive electrode material (i.e., during a lithium deintercalation process). Meanwhile, the flexible coating body can provide a uniform lithium ion transmission interface for lithium ion deintercalation, thereby reducing side reactions caused by easy breakage of the ternary positive electrode active material particles and addressing the problem of finally affecting the cycle performance and safety performance of the battery, and thereby improving the cycle performance and safety performance of the battery.

Some embodiments are listed below, but it should be noted that the following embodiments are not exhaustive of all possible cases, and the materials used in the following embodiments can be obtained from commercial sources unless otherwise specified.

### Embodiment 1

A ternary positive electrode active material was LiNi_{1/3}Co_{1/3}Mn_{1/3}O₂.

Preparation of a flexible coating: stirring and dispersing 0.1 kg of aniline monomer in 100 L of deionized water uniformly, then adding 0.1 kg of polyamide elastomer powder, stirring for 15 minutes at 100 RPM to enable the aniline monomer to be fully adsorbed on a surface of the polyurethane elastomer powder, then slowly dropping 0.4 L of oxidant (H₂O₂ solution with a concentration of 3%), carrying out in-situ oxidation polymerization reaction on the aniline monomer in the polyamide elastomer at room temperature, filtering after the reaction was finished (25 hours), washing with deionized water, and carrying out vacuum drying at 60° C. for 24 hours to obtain the flexible coating.

Preparation of a high-voltage ternary positive electrode material: putting 0.1 kg of the flexible coating in NMP and stirring to obtain a dispersion; and adding 5 kg of the ternary positive electrode active material into the dispersion, stirring, and evaporating the solvent to obtain the positive electrode material.

### Embodiment 2

A ternary positive electrode active material was LiNi_{0.8}Co_{0.1}Mn_{0.1}O₂.

Preparation of a flexible coating: dissolving 1 kg of phosphotungstic acid in 100 L of deionized water, adding 0.125 kg of aniline monomer to stir and disperse uniformly, then adding 0.125 kg of polyamide elastomer powder, stirring for 20 minutes at 100 RPM to enable the aniline monomer to be fully adsorbed on a surface of the polyurethane elastomer powder, then slowly dropping 0.4 L of oxidant (H₂O₂ solution with a concentration of 3%), carrying out in-situ oxidation polymerization reaction on the aniline monomer in the polyamide elastomer at room temperature, filtering after the reaction was finished (about 23 hours), washing with deionized water, and carrying out vacuum drying at 55° C. for 25 hours to obtain the flexible coating.

Preparation of a high-voltage ternary positive electrode material: putting 0.1 kg of the flexible coating in NMP and stirring to obtain a dispersion; and adding 3 kg of the ternary positive electrode active material into the dispersion, stirring, and evaporating the solvent to obtain the positive electrode material.

### Embodiment 3

A ternary positive electrode active material was LiNi_{0.8}Co_{0.1}Mn_{0.1}O₂.

Preparation of a flexible coating: dissolving 1 kg of phosphotungstic acid in 100 L of deionized water, adding 0.2 kg of aniline monomer to stir and disperse uniformly, then adding 0.4 kg of polyamide elastomer powder, stirring for 20 minutes at 100 RPM to enable the aniline monomer to be fully adsorbed on a surface of the polyurethane elastomer powder, then slowly dropping 0.6 L of oxidant (H₂O₂ solution with a concentration of 3%), carrying out in-situ oxidation polymerization reaction on the aniline monomer in the polyamide elastomer at room temperature, filtering after the reaction was finished (25 hours), washing with deionized water, and carrying out vacuum drying at 60° C. for 24 hours to obtain the flexible coating.

Preparation of a high-voltage ternary positive electrode material: putting 0.1 kg of the flexible coating in NMP and stirring to obtain a dispersion; and adding 2 kg of the ternary positive electrode active material into the dispersion, stirring, and evaporating the solvent to obtain the positive electrode material.

### Embodiment 4

A ternary positive electrode active material was LiNi_{1/3}Co_{1/3}Mn_{1/3}O₂.

Preparation of a flexible coating: dissolving 1 kg of phosphotungstic acid in 100 L of deionized water, adding 0.1 kg of aniline monomer to stir and disperse uniformly, then adding 0.08 kg of polyamide elastomer powder, stirring for 15 minutes at 100 RPM to enable the aniline monomer to be fully adsorbed on a surface of the polyurethane elastomer powder, then slowly dropping 0.4 L of oxidant (H₂O₂ solution with a concentration of 3%), carrying out in-situ oxidation polymerization reaction on the aniline monomer in the polyamide elastomer at room temperature, filtering after the reaction was finished (20 hours), washing with deionized water, and carrying out vacuum drying at 60° C. for 20 hours to obtain the flexible coating.

Preparation of a high-voltage ternary positive electrode material: putting 0.1 kg of the flexible coating in NMP and stirring to obtain a dispersion; and adding 1.25 kg of the ternary positive electrode active material into the dispersion, stirring, and evaporating the solvent to obtain the positive electrode material.

### Comparative Example 1

A ternary positive electrode active material was LiNi_{0.8}Co_{0.1}Mn_{0.1}O₂.

A coating was polyaniline.

A preparation method of a high-voltage ternary positive electrode material was: putting 0.1 kg of polyaniline in NMP and stirring to obtain a dispersion; and adding 2 kg of the ternary positive electrode active material into the dispersion, stirring, and evaporating the solvent to obtain the positive electrode material.

### Comparative Example 2

A ternary positive electrode active material was LiNi_{0.8}Co_{0.1}Mn_{0.1}O₂.

A coating was polyurethane elastomer.

A preparation method of a high-voltage ternary positive electrode material was: putting 0.1 kg of polyurethane elastomer in NMP and stirring to obtain a dispersion; and adding 2 kg of the ternary positive electrode active material into the dispersion, stirring, and evaporating the solvent to obtain the positive electrode material.

### Comparative Example 3

A ternary positive electrode active material was LiNi_{0.8}Co_{0.1}Mn_{0.1}O₂.

A coating was a mixture of polyaniline and polyurethane elastomer, and a mass ratio of the polyaniline to the polyurethane elastomer was 1:2.

A preparation method of the coating was: blending, melting and granulating polyamide elastomer powder and polyaniline.

A preparation method of a high-voltage ternary positive electrode material was: putting 0.1 kg of polyurethane elastomer in NMP and stirring to obtain a dispersion; and adding 2 kg of the ternary positive electrode active material into the dispersion, stirring, and evaporating the solvent to obtain the positive electrode material.

### Comparative Example 4

A ternary positive electrode active material was LiNi_{0.8}Co_{0.1}Mn_{0.1}O₂.

A coating was a mixture of modified polyaniline doped with phosphotungstic acid and a polyurethane elastomer (a proportion of the phosphotungstic acid in the modified polyaniline doped with phosphotungstic acid to an aniline monomer was the same as that in Embodiment 3), and a mixing proportion of the modified polyaniline doped with phosphotungstic acid to the polyurethane elastomer was calculated by a mass ratio that the aniline monomer to the polyurethane=1:2.

A preparation method of the coating was: blending, melting and granulating polyamide elastomer powder and the modified polyaniline doped with phosphotungstic acid.

A preparation method of a high-voltage ternary positive electrode material was: putting 0.1 kg of the coating in NMP and stirring to obtain a dispersion; and adding 2 kg of the ternary positive electrode active material into the dispersion, stirring, and evaporating the solvent to obtain the positive electrode material.

The positive electrode materials obtained in Embodiments 1 to 4 and Comparative Examples 1 to 4 were prepared into button batteries, and electrochemical performances of lithium ion batteries were tested. Preparation steps of the button battery were as follows: taking N-methylpyrrolidone as a solvent, and uniformly mixing the positive electrode active material with acetylene black and PVDF in a mass ratio of 8:1:1, coating the mixture on an aluminum foil, carrying out forced air drying at 80° C. for 8 hours, and carrying out vacuum drying at 120° C. for 12 hours. The battery was assembled in an argon-protected glove box with a metallic lithium plate as a negative electrode, a polypropylene membrane as a separator, and 1MLiPF6-EC/DMC (1:1, v/v) as an electrolyte.

The button battery was tested for its discharge capacity at 0.1 C and at a cutoff voltage of 4.45 V, and its capacity retention rate at 0.1 C after 50 cycles of charge and discharge at a cutoff voltage of 4.45 V and an environment of 25° C., and the results were shown in Table 1.

TABLE 1
Electrochemical performances of button batteries prepared
by the positive electrode materials obtained in Embodiments
1 to 4 and Comparative Examples 1 to 4

Electrochemical performance

| | Discharge | |
|---|---|---|
| | capacity at 0.1 C | Cycle retention |
| Button battery | mAh/g | rate at 0.1 C |
| Embodiment 1 | 197.5 | 86.9% |
| Embodiment 2 | 225.7 | 95.2% |
| Embodiment 3 | 212.4 | 91.7% |
| Embodiment 4 | 209.1 | 92.6% |
| Comparative Example 1 | 158.3 | 75.7% |
| Comparative Example 2 | 165.0 | 83.0% |
| Comparative Example 3 | 131.2 | 78.1% |
| Comparative Example 4 | 136.4 | 79.1% |

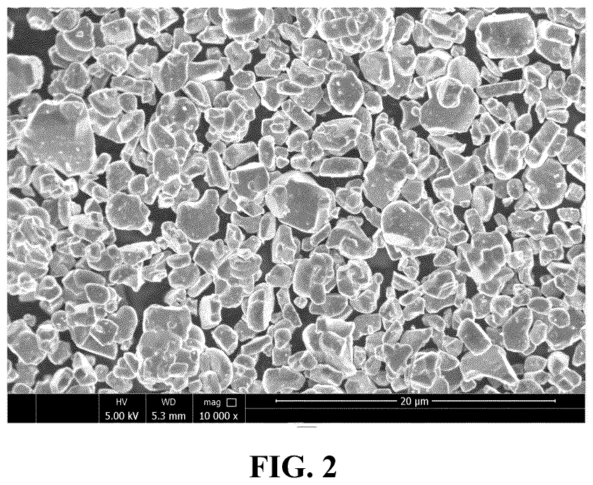

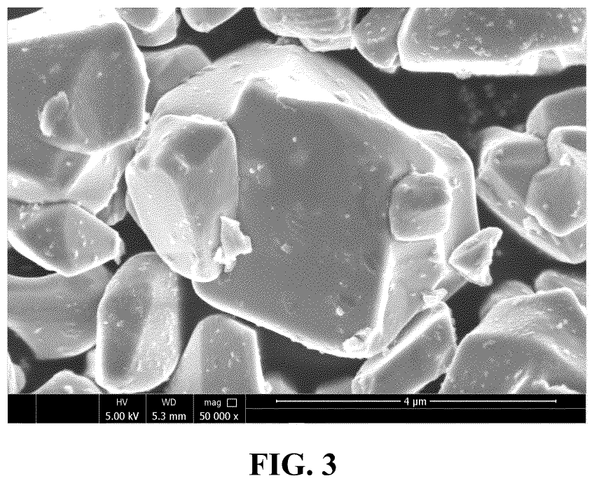

It can be seen from Table 1 that the button battery of Embodiment 1 has higher discharge capacity, specific discharge capacity after cycle and cycle retention rate in comparison to the button batteries of Comparative Examples 1 to 2, which indicates that coating the ternary positive electrode active material with the mixture of the polyaniline and the polyurethane elastomer better enables the high-voltage ternary positive electrode material to have better discharge capacity and the cycle retention rate; the button batteries of Embodiments 2 to 4 have higher discharge capacity and cycle retention rate in comparison to the button batteries of Comparative Examples 3 to 4, as shown in FIG. 2 and FIG. 3, which indicates that the uniformity of the modified polyaniline doped with phosphotungstic acid polyurethane elastomer and the polyurethane elastomer on the surface of the ternary positive electrode active material obtained through the in-site oxidation polymerization in the preparation method of the high-voltage ternary positive electrode material according to the present application is better, and the coating uniformity of the ternary positive electrode active material is better, and the ternary positive electrode active material obtained through the preparation method of the high-voltage ternary positive electrode material according to the present application has better discharge capacity and cycle retention rate.

The above embodiments merely express several embodiments of present invention, and the descriptions thereof are more specific and detailed, but cannot be understood as a limitation to the scope of the present invention. It should be noted that those of ordinary skills in the art may make a plurality of decorations and improvements without departing from the concept of the present invention, and these decorations and improvements shall all fall within the protection scope of the present invention. Therefore, the protection scope of the invention patent should be subjected to the claims appended.

1. A high-voltage ternary positive electrode material, comprising ternary positive electrode active material particles and a flexible coating body, the flexible coating body being coated on surfaces of the ternary positive electrode active material particles;
wherein, the flexible coating body comprises a mixture of polyaniline and a polyurethane elastomer.

2. The high-voltage ternary positive electrode material according to claim 1, wherein the ternary positive electrode active material is Li₁₊ₓNiₐCo_{b}Mn_{c}O₂, 1/3≤a≤0.8, 0.1≤b≤1/3, 0.1≤c≤1/3, 0≤x<0.2, and a+b+c=1.

3. The high-voltage ternary positive electrode material according to claim 1, wherein the ternary positive electrode active material is LiNi_{1/3}Co_{1/3}Mn_{1/3}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂ or LiNi_{0.8}Co_{0.1}Mn_{0.1}O₂.

4. The high-voltage ternary positive electrode material according to claim 1, wherein the polyaniline is modified polyaniline doped with phosphotungstic acid.

5. A preparation method of a high-voltage ternary positive electrode material, used for preparing the high-voltage ternary positive electrode material according to claim 1, wherein the preparation method of the high-voltage ternary positive electrode material comprises the following steps of:
acquiring a flexible coating;
dispersing the flexible coating; and
adding the ternary positive electrode active material into the dispersed flexible coating for coating operation, so that surfaces of ternary positive electrode active material particles are coated with a flexible coating body to obtain the high-voltage ternary positive electrode material.

6. The preparation method of the high-voltage ternary positive electrode material according to claim 5, wherein acquiring the flexible coating specifically comprises the following steps of:
acquiring aniline;
adding polyurethane elastomer into the aniline for dispersion and adhering operations, so that the aniline is adhered to the polyurethane elastomer to obtain a coating liquid; and
carrying out in-situ oxidation polymerization operation on the coating liquid to obtain the flexible coating.

7. The preparation method of the high-voltage ternary positive electrode material according to claim 6, wherein a mass ratio of the aniline to the polyurethane elastomer is (0.5 to 1.25):1.

8. The preparation method of the high-voltage ternary positive electrode material according to claim 6, wherein before the step of adding the polyurethane elastomer into the aniline for dispersion and adhering operations, acquiring the flexible coating specifically further comprises the following step of:
dispersing and mixing the aniline and a phosphotungstic acid.

9. The preparation method of the high-voltage ternary positive electrode material according to claim 8, wherein a mass ratio of the aniline to the phosphotungstic acid is 1:(5 to 10).

10. The preparation method of the high-voltage ternary positive electrode material according to claim 8, wherein H₂O₂ is used to carry out the in-situ oxidation polymerization operation on the coating liquid.

11. A preparation method of a high-voltage ternary positive electrode material, used for preparing the high-voltage ternary positive electrode material according to claim 2, wherein the preparation method of the high-voltage ternary positive electrode material comprises the following steps of:
acquiring a flexible coating;
dispersing the flexible coating; and
adding the ternary positive electrode active material into the dispersed flexible coating for coating operation, so that surfaces of ternary positive electrode active material particles are coated with a flexible coating body to obtain the high-voltage ternary positive electrode material.

12. A preparation method of a high-voltage ternary positive electrode material, used for preparing the high-voltage ternary positive electrode material according to claim 3, wherein the preparation method of the high-voltage ternary positive electrode material comprises the following steps of:
acquiring a flexible coating;
dispersing the flexible coating; and
adding the ternary positive electrode active material into the dispersed flexible coating for coating operation, so that surfaces of ternary positive electrode active material particles are coated with a flexible coating body to obtain the high-voltage ternary positive electrode material.

13. A preparation method of a high-voltage ternary positive electrode material, used for preparing the high-voltage ternary positive electrode material according to claim 4, wherein the preparation method of the high-voltage ternary positive electrode material comprises the following steps of:
acquiring a flexible coating;
dispersing the flexible coating; and
adding the ternary positive electrode active material into the dispersed flexible coating for coating operation, so that surfaces of ternary positive electrode active material particles are coated with a flexible coating body to obtain the high-voltage ternary positive electrode material.
